(19) United States
(12) Patent Application Publication
(10) Pub. No.: US 2026/0184271 A1
(43) Pub. Date: Jul. 2, 2026

(54) VEHICLE SEAT

(71) Applicants: TS TECH CO., LTD., Asaka-shi (JP); HONDA MOTOR CO., LTD., Tokyo (JP)

(72) Inventors: Sachio KOBAYASHI, Shioya-gun (JP); Makoto SHIBUYA, Shioya-gun (JP); Kenta EBARA, Shioya-gun (JP); Manabu MATSUMOTO, Wako-shi (JP)

(21) Appl. No.: 19/431,093

(22) Filed: Dec. 23, 2025

(30) Foreign Application Priority Data
Dec. 26, 2024 (JP) 2024-231058

(51) Int. Cl. B60R 16/02; B60N 2/68

(52) U.S. Cl. CPC B60R 16/0215; B60N 2/68

(57) ABSTRACT

A vehicle seat includes: a cushion frame that includes a pair of left and right side frames, a first connecting frame that connects one ends of the pair of left and right side frames to each other, and a second connecting frame that connects other ends of the pair of left and right side frames to each other; a pressure receiver that is disposed between the pair of left and right side frames and receives a load from a seat occupant; an electric component that is installed in the cushion frame; a harness that is connected to the electric component; and a harness movement suppresser that is installed to suppress downward movement by the harness.

### CROSS-REFERENCE TO RELATED APPLICATION

This application is based upon and claims the benefit of priority from the prior Japanese Patent Application No. 2024-231058, filed on December 26, 2024, the entire contents of which are incorporated herein by reference.

### BACKGROUND OF THE INVENTION

### TECHNICAL FIELD

The present disclosure pertains to a vehicle seat.

### DESCRIPTION OF RELATED ART

In the past, in order to prevent drooping by a harness that is connected to electric components mounted to the seat of an automobile and is disposed on the bottom surface of the seat, a vehicle seat provided with a covering that covers and supports at least a portion of the harness is known (for example, refer to Japanese Patent No. 6366446).

However, in the case of the vehicle seat in the abovementioned Japanese Patent No. 6366446, complicated work for disposing the covering onto the seat in a state where the harness has gone through a slit formed in the covering is required, and thus there are cases where work for assembling the vehicle seat becomes difficult.

### SUMMARY OF THE INVENTION

An objective of the present disclosure is to provide a vehicle seat that enables a harness that is disposed in the seat to be supported by a comparatively simple configuration.

To achieve at least one of the abovementioned objects, according to an aspect of the present disclosure, there is provided a vehicle seat, including:

a cushion frame that includes a pair of left and right side frames, a first connecting frame that connects one ends of the pair of left and right side frames to each other, and a second connecting frame that connects other ends of the pair of left and right side frames to each other;

a pressure receiver that is disposed between the pair of left and right side frames and receives a load from a seat occupant;

an electric component that is installed in the cushion frame;

a harness that is connected to the electric component; and

a harness movement suppresser that is installed to suppress downward movement by the harness.

### BRIEF DESCRIPTION OF DRAWINGS

The accompanying drawings are not intended as a definition of the limits of the invention but illustrate embodiments of the invention, and together with the general description given above and the detailed description of the embodiments given below, serve to explain the principles of the invention, wherein:

FIG. 1 is a perspective view that illustrates a vehicle seat according to the present embodiment;

FIG. 2 is a perspective view that illustrates a cushion frame of the vehicle seat according to the present embodiment;

FIG. 3 is a top-surface view that illustrates the cushion frame of the vehicle seat according to the present embodiment;

FIG. 4 is a bottom view that illustrates the main part of the vehicle seat according to the present embodiment;

FIG. 5 is a side-surface view that illustrates the main part of the vehicle seat according to the present embodiment;

FIG. 6 is a perspective view that illustrates, in an enlarged fashion, a harness movement suppresser belonging to the vehicle seat according to the present embodiment; and

FIG. 7 is a perspective view that illustrates the harness movement suppresser.

### DETAILED DESCRIPTION

With reference to the drawings, description is given in detail below regarding an embodiment of a vehicle seat according to the present disclosure. However, various limitations that are technically desirable in order to carry out the present disclosure are added to the embodiment that is described below, but the scope of the present disclosure is not limited to the following embodiment or illustrated examples.

Note that description is given below by defining a forward-backward direction, a left-right direction, and an up-down direction. The backrest side of a seat is referred to as "backward", the side opposite is referred to as "forward", the left-hand side in a state where forward while being seated in the seat is regarded as a front view is referred to as "left", the right-hand side in a state where forward while being seated in the seat is regarded as a front view is referred to as "right", and the up-down direction conforms to the vertical direction. In other words, the width direction of the seat corresponds to the left-right direction.

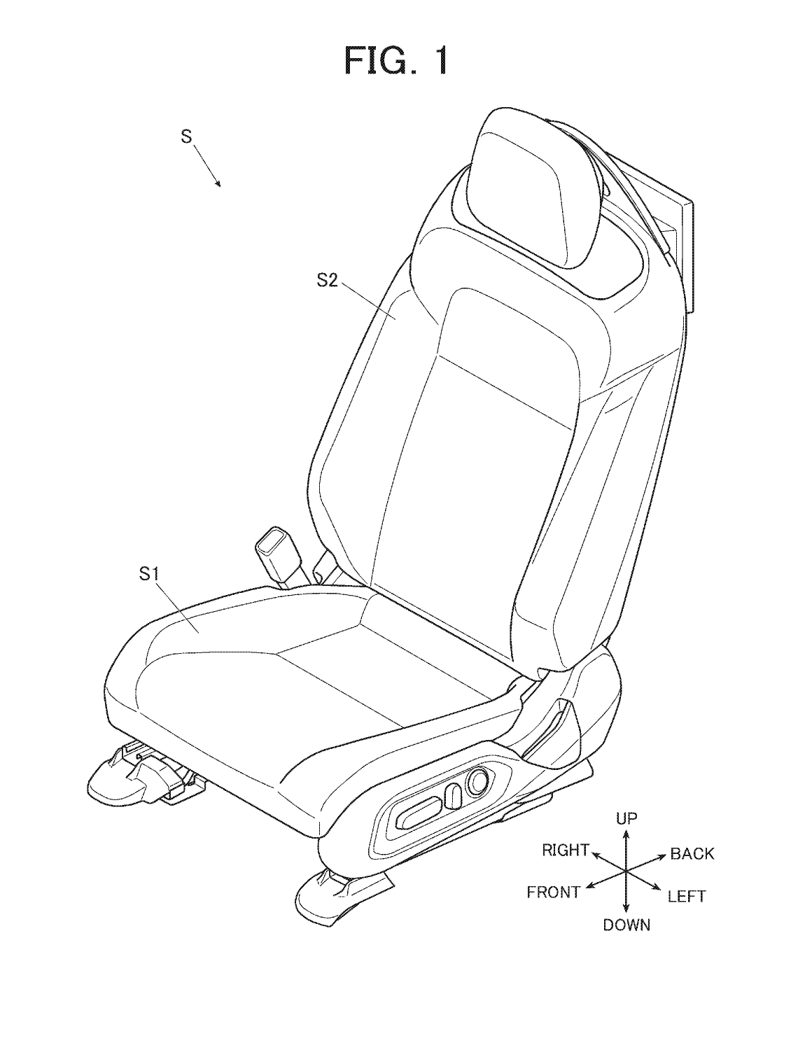

As illustrated in FIG. 1, for example, a vehicle seat S according to the present embodiment is provided with a seat cushion S1 that serves as a seat, and a seatback S2 that serves as a backrest.

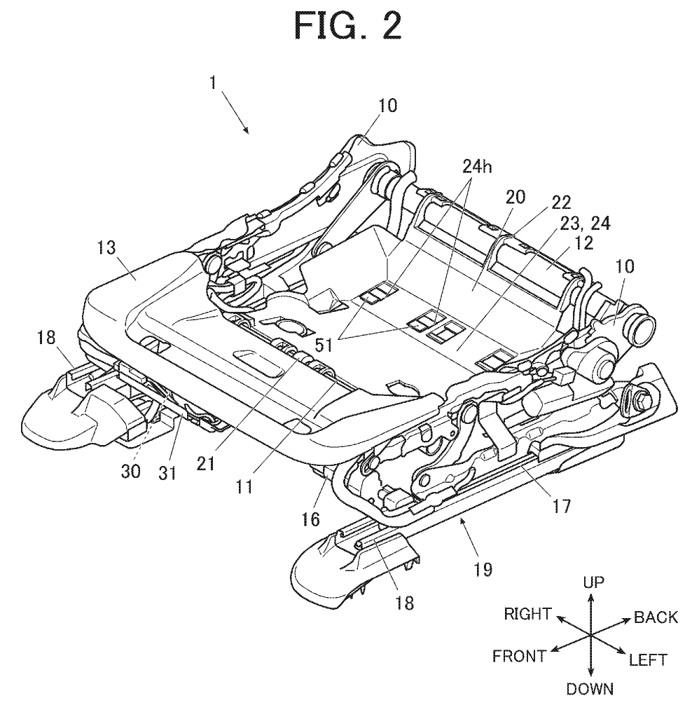

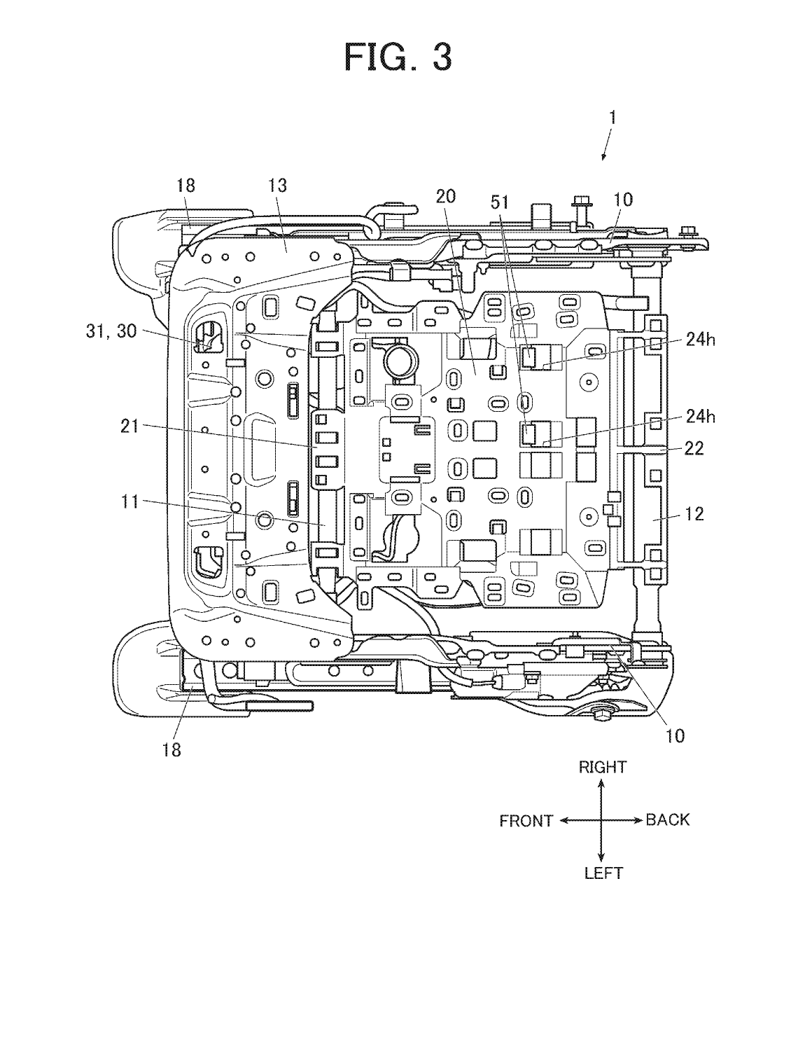

A cushion frame 1 as illustrated in FIG. 2 and FIG. 3, for example, is incorporated inside the seat cushion S1.

The seat cushion S1 is configured by covering the cushion frame 1 with padding made from urethane foam or the like, and covering the pad with a covering material made from fabric, leather, or the like.

In addition, although illustration is omitted, the seatback S2 is similarly configured by covering a back frame that serves as a frame with padding and a covering material.

As illustrated in FIG. 2 and FIG. 3, for example, the cushion frame 1 has a pair of left and right side frames 10, a first connecting frame 11 that connects one end of each of the pair of left and right side frames to each other, and a second connecting frame 12 that connects other ends of the pair of left and right side frames to each other.

The cushion frame 1 also has a pan frame 13 that is disposed forward of the first connecting frame 11.

Note that the pair of left and right side frames 10 exhibit shapes that are asymmetric to the left and right.

The side frames 10 are each made from a metal plate, and are disposed as a pair that are separated to the left and right.

The first connecting frame 11 and the second connecting frame 12 are disposed separated forward/backward from one another.

The first connecting frame 11 is a so-called front frame made from a metal pipe having a circular cross section, and connects front portions of the pair of side frames 10 to each other.

The second connecting frame 12 is a so-called rear frame made from a metal pipe having a circular cross section, and connects rear portions of the pair of side frames 10 to each other.

The pan frame 13 is made from a metal plate, and connects front portions of the pair of side frames 10 to each other at a position that is forward of the first connecting frame 11.

In addition, the cushion frame 1 is installed into a vehicle with a slide rail mechanism 19 or the like interposed therebetween.

The slide rail mechanism 19 includes a pair of lower rails 18 that are disposed separated to the left and right and extend in the forward-backward direction, and a pair of upper rails 17 that respectively engage with the lower rails 18 in a manner that enables the pair of upper rails 17 to slide forward or backward with respect to the lower rails 18.

The lower rails 18 are secured to the floor of the vehicle (not illustrated), and the upper rails 17, which are disposed in a manner that enables the upper rails 17 to slide with respect to the lower rails 18, are secured to the cushion frame 1.

In other words, the vehicle seat S is installed onto the floor of the vehicle in a manner that enables the vehicle seat S to slidingly move forward and backward.

The slide rail mechanism 19 according to the present embodiment is of an electrically actuated slide type that is driven by a motor 16 disposed on the upper rail 17 side to cause the seat to slidingly move forward or backward by causing the upper rails 17 to move along the lower rails 18.

For example, the motor 16, which is disposed in the cushion frame 1 on the upper rail 17 side, causes a pinion gear that meshes with racks provided along the direction of extension by the lower rails 18 to rotate, whereby the upper rails 17 are causes to move along the lower rails 18. Note that the configuration or operation of the electrically actuated slide type slide rail mechanism 19 is similar to that conventionally known, and detailed description is not given here.

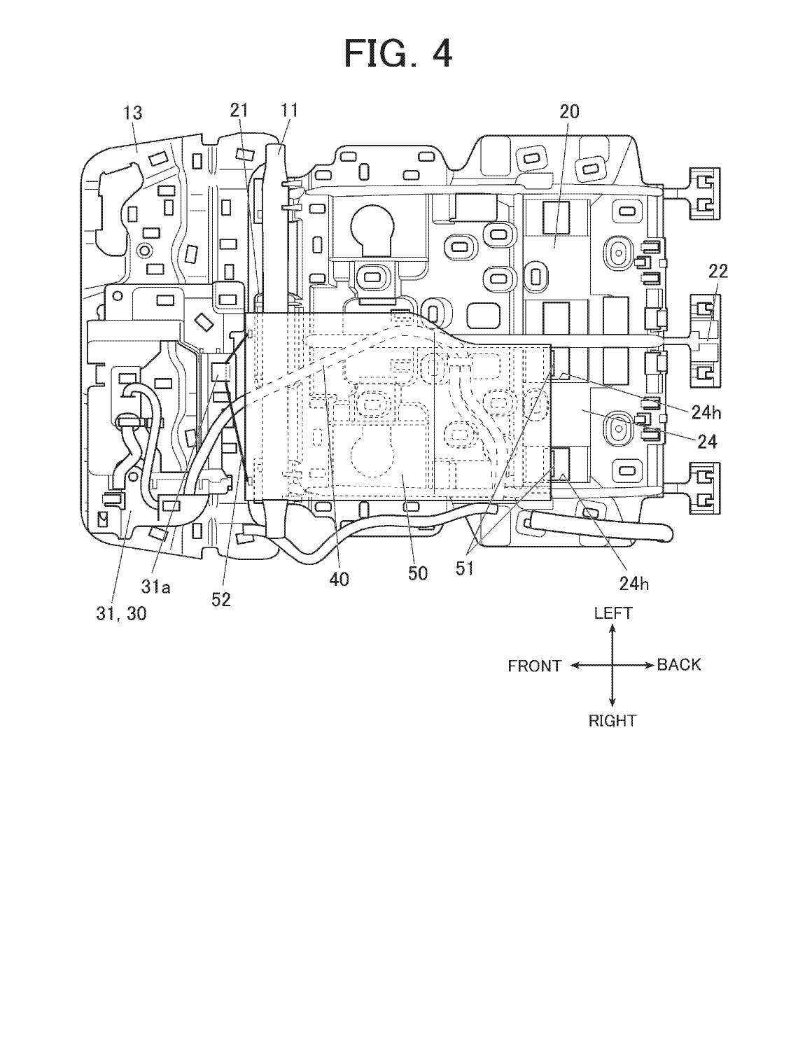

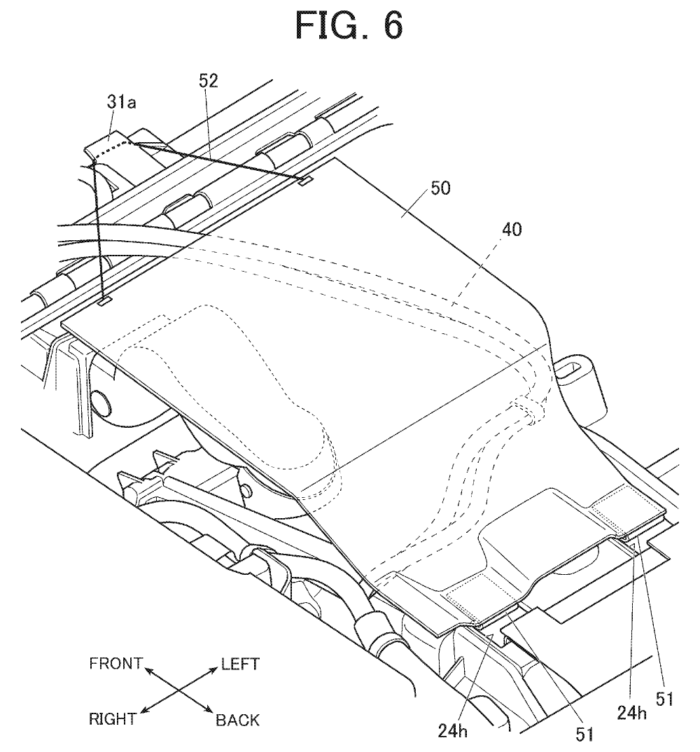

For example, as illustrated in FIG. 2 to FIG. 6, the vehicle seat S according to the present embodiment includes: the cushion frame 1 that has a pair of left and right side frames 10, the first connecting frame 11 that connects the front of each of the pair of left and right side frames 10 to each other, the second connecting frame 12 that connects the back of the pair of left and right side frames 10 to each other, and the pan frame 13 that is disposed forward of the first connecting frame 11; a pressure receiver 20 that is disposed between the pair of left and right side frames 10 and receives a load from a seat occupant; an electric component 30 that is installed in the cushion frame 1; a harness 40 that is connected to the electric component 30; and a harness movement suppresser 50 that is installed so as to support the harness 40 from below in order to suppress downward movement by the harness 40.

As described above, the vehicle seat S according to the present embodiment is provided with the electric component 30, and the harness movement suppresser 50 is disposed in order to suppress movement such as the harness 40, which is connected in order to supply electric power to the electric component 30, slackening and drooping down.

For example, in a case where one end of the harness 40 is connected to the electric component 30 that is installed to the cushion frame 1 and the other end of the harness 40 is connected to the vehicle floor side, the one end of the harness 40 and the other end thereof get closer when the vehicle seat S is caused to slidingly move forward/backward, whereby it may be that slack arises in the harness 40 and drooping such as a portion of the harness 40 moving downward occurs.

Even if the harness 40 slackens and droops in this manner, the harness movement suppresser 50 supports the harness 40 from below, whereby the harness 40 is suppressed from moving lower than the harness movement suppresser 50.

Description is given below regarding the vehicle seat S that is provided with the harness movement suppresser 50.

The pressure receiver 20 is a metallic plate material that receives a load from a seat occupant, a front end 21 thereof catches onto the first connecting frame 11, a rear end 22 there of catches onto the second connecting frame 12, and the pressure receiver 20 is suspended between the first connecting frame 11 and the second connecting frame 12.

An accommodating recess 23 that can accommodate a pad is provided between the front end 21 and the rear end 22 of the pressure receiver 20, and a flat portion 24 that includes a flat region is formed on the bottom surface of the accommodating recess 23.

Attachment holes 24h for mounting the harness movement suppresser 50 are formed in the flat portion 24 of the accommodating recess 23. A pair of left and right attachment holes 24h are formed in the flat portion 24.

Note that the vicinity of the bottom surface of the accommodating recess 23, such as a range that extends from the front end 21 to the bottom surface of the accommodating recess 23 or a range that extends from the rear end 22 to the bottom surface of the accommodating recess 23 is for the most part configured by a sloped surface that goes down from the edge of the accommodating recess 23 to the bottom surface thereof.

The electric component 30 is mounted to the bottom surface of the pan frame 13 in the cushion frame 1, with a bracket 31 interposed between the electric component 30 and the bottom surface.

The bracket 31 is provided with a hook 31a for mounting the harness movement suppresser 50.

The electric component 30 according to the present embodiment is a blower for suctioning air into the seat cushion S1.

Note that the electric component 30 is disposed at a position that is at the right on the front side of the cushion frame 1, so as to not interfere with the motor 16 for the slide rail mechanism 19.

The harness 40 is a cable for supplying electric power to the electric component 30, and the majority of the harness 40 is wired in order to pass below the pressure receiver 20.

The harness 40 is disposed extending in the forward-backward direction for the vehicle seat S.

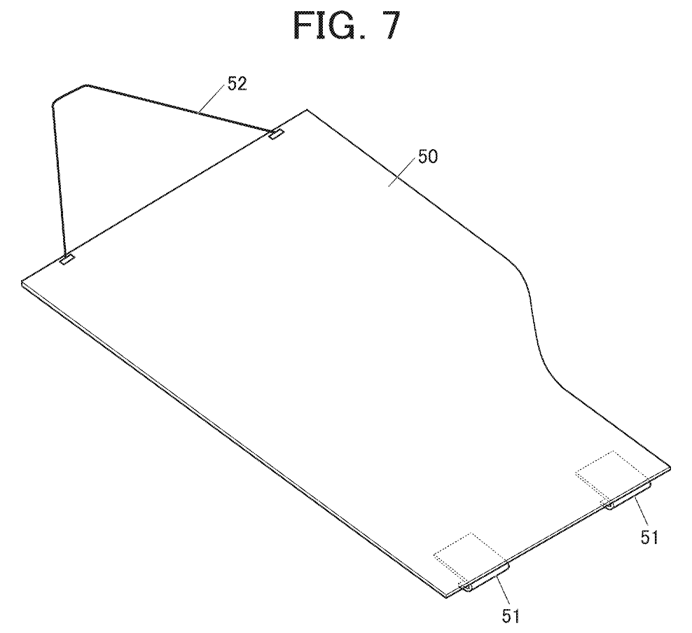

For example, as illustrated in FIG. 7, the harness movement suppresser 50 has first attachments 51 that are attached to the pressure receiver 20 in order to mount the harness movement suppresser 50 to the pressure receiver 20, and a second attachment 52 that is attached to the bracket 31 in order to mount the harness movement suppresser 50 to the bracket 31 for the electric component 30.

In other words, the harness movement suppresser 50 has the first attachments 51 and the second attachment 52 in order to mount the harness movement suppresser 50 to the vehicle seat S.

The harness movement suppresser 50 is a sheet-shaped member made from fabric or a resin sheet material, and the size of the harness movement suppresser 50 enables a prescribed range to be covered.

The width of the harness movement suppresser 50 according to the present embodiment enables approximately half of one side of the pressure receiver 20 (half of one side in the left-right direction) to be covered, and the harness movement suppresser 50 enables a region in which the harness 40 is wired to be covered for the most part.

In particular, the harness movement suppresser 50 is formed such that the width of one end side of the harness movement suppresser 50 in which the second attachment 52 is provided becomes wider than the width of the other end side of the harness movement suppresser 50 in which the first attachments 51 are provided.

Each first attachment 51 is a hook-shaped member that is attached to the flat portion 24 of the pressure receiver 20, and the hook-shaped first attachment 51 is attached to the attachment hole 24h formed in the flat portion 24.

Here, a pair of left and right first attachments 51 are securely installed to the other end of the harness movement suppresser 50 and the pair of first attachments 51 are attached to the pair of attachment holes 24h formed in the flat portion 24, whereby it is possible to mount the other end of the harness movement suppresser 50 to the pressure receiver 20.

For example, these first attachments 51 are hook-shaped members that are made of resin and exhibit a substantially J shape in a side-surface view, and are securely installed by being sewn onto the other end of the harness movement suppresser 50.

The second attachment 52 is a band member that has elasticity and is attached to the bracket 31 for the electric component 30, and the second attachment 52, which is a band member, is attached to the hook 31a that is formed on the bracket 31.

Both ends of the band member that is the second attachment 52 are securely installed by being sewn onto one end of the harness movement suppresser 50, and a handle-shaped band member (second attachment 52) is attached to the hook 31a of the bracket 31, whereby the one end of the harness movement suppresser 50 can be mounted to the bracket 31 for the electric component 30.

For example, this second attachment 52 is a band member that is made of rubber, both ends of this band member are sewn onto the one end of the harness movement suppresser 50 at separated locations, whereby this band member is securely installed so as to exhibit a handle shape at the one end of the harness movement suppresser 50.

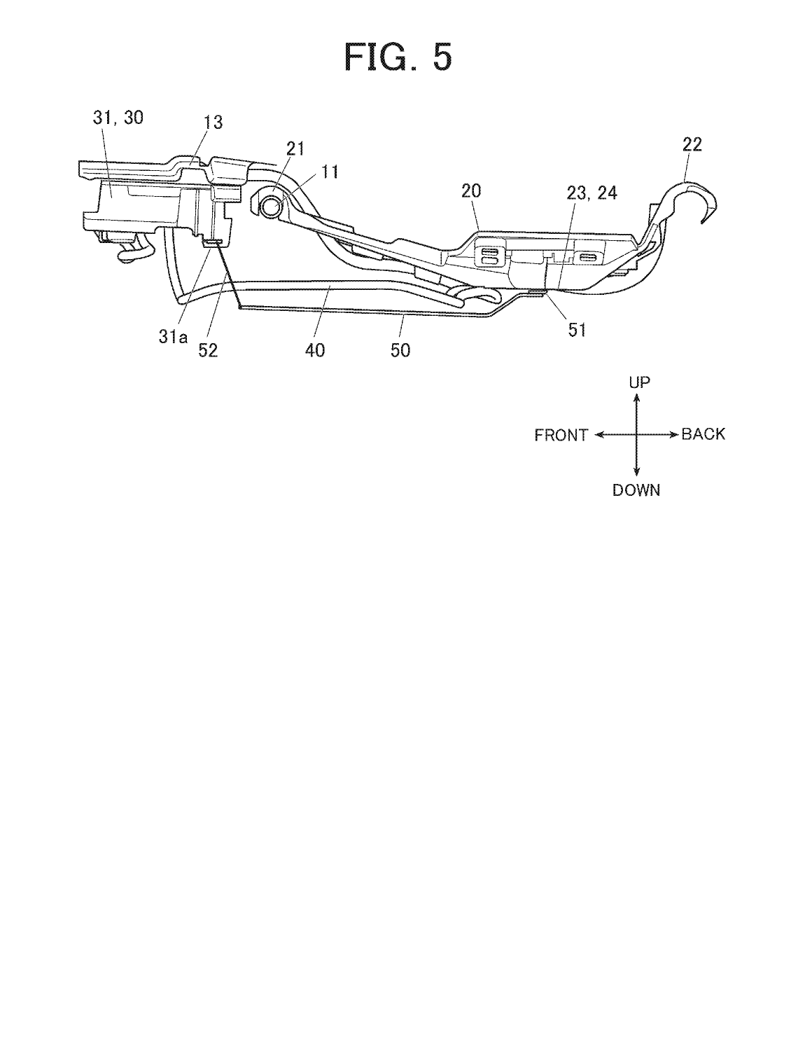

The second attachment 52 attached to the bracket 31 for the electric component 30 is attached at a position that is higher than the position at which the first attachment 51 is attached to the flat portion 24 of the pressure receiver 20 (refer to FIG. 5).

As a result, there is action such that the one end side of the harness movement suppresser 50 that is disposed at a position near the electric component 30 is pulled up by the second attachment 52 toward a high position, and thus it becomes easier to suppress downward movement by the harness 40 that is connected to the electric component 30.

In addition, the width of the one end side of the harness movement suppresser 50 where the second attachment 52 is provided is formed to be a size that is wider than the width of the other end side of the harness movement suppresser 50 where the first attachment 51 is provided, the harness movement suppresser 50 being a sheet-shaped member.

In this manner, by widening the width of the one end side of the harness movement suppresser 50 where the second attachment 52 that is attached to the bracket 31 for the electric component 30 is provided, namely the width of the one end side of the harness movement suppresser 50 that is disposed at a position near the electric component 30, it is possible to support the harness 40 that is connected to the electric component 30 over a wide range, and it becomes easier to suppress downward movement by the harness 40 that is connected to the electric component 30.

As above, the vehicle seat S according to the present embodiment is provided with the harness movement suppresser 50 that suppresses downward movement by the harness 40 that is connected to the electric component 30. Therefore, even if the harness 40 slackens and droops, the harness movement suppresser 50 can support the harness 40 from below, and the harness 40 does not move down past the harness movement suppresser 50.

With such a vehicle seat S, even if the harness 40 slackens and droops, it is possible to suppress downward movement past the harness movement suppresser 50 by the harness 40, and thus it is possible to reduce the occurrence of the harness 40 being damaged by coming into contact with the floor of the vehicle, and the like.

In particular, the harness movement suppresser 50 that is a sheet-shaped member is used in the vehicle seat S, and it becomes possible to support the harness 40 that is disposed in the vehicle seat S by a comparatively simple configuration in which the first attachments 51 that are hook-shaped members are provided to the other end of the harness movement suppresser 50, and the second attachment 52 that is a band member having elasticity is provided to one end.

In addition, the harness movement suppresser 50 has a comparatively compact size that enables approximately half of one side of the pressure receiver 20 to be covered and is thus easy to handle, enabling work to install the harness movement suppresser 50 in the vehicle seat S to be easily performed.

Specifically, because the harness movement suppresser 50 is smaller than something that covers the entire region of the cushion frame 1 in the width direction thereof, it is possible to reduce the weight and reduce the cost thereof. In addition, because obstructing the arrangement of other components is also suppressed, the degree of freedom for design is improved. Furthermore, work for mounting the harness movement suppresser 50 is also facilitated.

In addition, the harness movement suppresser 50 is disposed while biased toward the side of the installation location of the electric component 30 where the harness 40 is wired, and thus it is possible to efficiently support the harness 40 while suppressing the size of the harness movement suppresser 50.

Description is given here for a procedure for installing the harness movement suppresser 50 in the vehicle seat S in order to support the harness 40 disposed in the vehicle seat S by the harness movement suppresser 50.

Firstly, the harness movement suppresser 50 is inserted under the seat cushion S1 from the front side of the vehicle seat S, and the hook-shaped members (first attachments 51) provided at the other end of the harness movement suppresser 50 are caused to be attached to the attachment holes 24h formed in the flat portion 24 of the pressure receiver 20.

Note that the attachment holes 24h are formed in the flat portion 24 that includes a flat region, and thus it is possible to cause the hook-shaped members (first attachments 51) to easily attach to the attachment holes 24h. For example, in a case where an attachment hole 24h is formed in a surface that has many recesses and projections or is highly uneven, the orientation of a hook-shaped member (first attachment 51) caused to attach to this attachment hole 24h will not be stable, and this is not preferable.

Next, in a state where the hook-shaped members (first attachments 51) have been caused to attach to the attachment holes 24h, the band member (second attachment 52) provided at the one end of the harness movement suppresser 50 is pulled such that harness movement suppresser 50 is pulled toward the front side of the vehicle seat S, and the band member (second attachment 52) is caused to attach to the hook 31a provided on the bracket 31 for the electric component 30.

Note that the band member (second attachment 52) has elasticity, and thus it is possible to easily attach the band member to the hook 31a of the bracket 31 by causing the band member to temporarily extend and contract.

In addition, by the action where the band member (second attachment 52) contracts, the one end of the harness movement suppresser 50 will be pulled up to the bracket 31 side of the electric component 30.

By such a procedure, it becomes possible to install the harness movement suppresser 50 on the bottom-surface side of the vehicle seat S, and it becomes possible to support the harness 40 disposed in the vehicle seat S by the harness movement suppresser 50.

With such a harness movement suppresser 50, it is possible to easily install the harness movement suppresser 50 on the bottom-surface side of the vehicle seat S by work for attaching the hook-shaped members (first attachments 51) to the attachment holes 24h and work for attaching the band member (second attachment 52) to the hook 31a.

In addition, the one end of the harness movement suppresser 50 is pulled up to the bracket 31 side of the electric component 30, and thus it is possible to suitably suppress downward movement by the harness 40 connected to the electric component 30.

In addition, the width of the one end side of the harness movement suppresser 50 disposed at a position near the electric component 30 is comparatively wide, and thus it is possible to widely support, by the harness movement suppresser 50, the harness 40 connected to the electric component 30, and it is possible to suitably suppress downward movement by the harness 40.

In this manner, with the vehicle seat S according to the present embodiment, the harness movement suppresser 50 can suitably suppress downward movement by the harness 40 that is connected to the electric component 30.

According to the above-described embodiments of the present invention, there is provided a vehicle seat, comprising: a cushion frame that includes a pair of left and right side frames, a first connecting frame that connects one ends of the pair of left and right side frames to each other, and a second connecting frame that connects other ends of the pair of left and right side frames to each other; a pressure receiver that is disposed between the pair of left and right side frames and receives a load from a seat occupant; an electric component that is installed in the cushion frame; a harness that is connected to the electric component; and a harness movement suppresser that is installed to suppress downward movement by the harness.

With this configuration, because the harness movement suppresser that suppresses downward movement by the harness connected to the electric component is provided, even if the harness slackens and droops, the harness movement suppresser can support the harness from below, and the harness does not move down past the harness movement suppresser.

It is preferred that the harness movement suppresser includes a first attachment that is attached to the pressure receiver.

With this configuration, the harness movement suppresser has the first attachment that is attached to the pressure receiver, and thus the harness movement suppresser can be easily mounted to the pressure receiver.

It is preferred that the pressure receiver includes a flat portion that includes a flat region, and the first attachment is attached to the flat portion.

With this configuration, because the pressure receiver has the flat portion that includes the flat region and the first attachment is attached to the flat portion, the harness movement suppresser can be easily mounted to the pressure receiver.

It is preferred that an attachment hole is formed in the flat portion, and the first attachment is a hook-shaped member and is attached to the attachment hole.

With this configuration, because the attachment hole is formed in the flat portion of the pressure receiver and the first attachment that is a hook-shaped member is attached to the attachment hole, the harness movement suppresser can be easily mounted to the pressure receiver.

It is preferred that the cushion frame includes a pan frame that is disposed forward of the first connecting frame, the electric component is mounted to the pan frame, with a bracket interposed between the electric component and the pan frame, and the harness movement suppresser includes a second attachment that is attached to the bracket.

With this configuration, because the harness movement suppresser has the second attachment that is attached to the bracket for the electric component, the harness movement suppresser can be easily mounted to the bracket for the electric component that is installed on the pan frame.

Because the pan frame is disposed forward of the first connecting frame in the cushion frame, it becomes possible to mount the harness movement suppresser to a wide range in the forward-backward direction, and it becomes possible to suitably support the harness that extends in the forward-backward direction for the vehicle seat.

It is preferred that the second attachment is attached at a position that is higher than a position of the first attachment.

With this configuration, because the second attachment is attached to a higher position than that of the first attachment, there is action whereby the one end side of the harness movement suppresser disposed at a position near the electric component is pulled up to a high position by the second attachment. Therefore, suppressing downward movement by the harness connected to the electric component is facilitated.

It is preferred that a hook is provided to the bracket, and the second attachment is a band member that has elasticity, and is attached to the hook.

With this configuration, the second attachment that is a band member having elasticity is attached to the hook of the bracket, whereby the harness movement suppresser can be easily mounted to the bracket for the electric component.

In addition, due to action where the band member that has been attached to the hook of the bracket contracting, the one end side of the harness movement suppresser is pulled up toward the bracket side of the electric component. Therefore, suppressing downward movement by the harness connected to the electric component is facilitated.

It is preferred that the harness movement suppresser is a sheet-shaped member.

With this configuration, because the harness movement suppresser is a sheet-shaped member made from fabric, a resin sheet material, or the like, it becomes possible to form the harness movement suppresser into a size or shape that correspond to a range in which the harness is wired, and suitably support the harness.

It is preferred that the harness movement suppresser is a sheet-shaped member, and a width of one end side of the sheet-shaped member at which the second attachment is provided is wider than a width of another end side of the sheet-shaped member at which the first attachment is provided.

With this configuration, because the harness movement suppresser is a sheet-shaped member made from fabric, a resin sheet material, or the like, it becomes possible to form the harness movement suppresser into a size or shape that correspond to a range in which the harness is wired, and suitably support the harness.

In particular, because the width of the one end side of the sheet-shaped member (harness movement suppresser) where the second attachment is provided is formed wider than the width of the other end side where the first attachment is provided and the width of the one end side of the harness movement suppresser that is disposed at a position near the electric component is wide, it becomes possible to widely support the harness that is connected to the electric component.

It is preferred that a width of the harness movement suppresser is shorter than a width of the pressure receiver.

With this configuration, because the harness movement suppresser is smaller than something that covers the entire region of the cushion frame in the width direction thereof, it is possible to reduce the weight and reduce the cost thereof.

In addition, because obstructing the arrangement of other components is also suppressed, the degree of freedom for design is improved. Furthermore, mounting of components is also facilitated.

It is preferred that the harness movement suppresser is disposed being biased toward a side of a location where the electric component is installed, in a width direction of the cushion frame.

With this configuration, the harness movement suppresser is disposed while biased toward the side of the installation location of the electric component where the harness is wired, and thus it is possible to efficiently support the harness 40 while suppressing the size of the harness movement suppresser 50.

Note that application of the present disclosure is not limited to the embodiment described above, and can be changed, as appropriate, within a scope that does not deviate from the gist of the present disclosure.

Although some embodiments of the present invention have been described and illustrated in detail, the disclosed embodiments are made for purposes of not limitation but illustration and example only. The scope of the present invention should be interpreted by terms of the appended claims.

1. A vehicle seat, comprising:
a cushion frame that includes a pair of left and right side frames, a first connecting frame that connects one ends of the pair of left and right side frames to each other, and a second connecting frame that connects other ends of the pair of left and right side frames to each other;
a pressure receiver that is disposed between the pair of left and right side frames and receives a load from a seat occupant;
an electric component that is installed in the cushion frame;
a harness that is connected to the electric component; and
a harness movement suppresser that is installed to suppress downward movement by the harness.

2. The vehicle seat according to claim 1, wherein the harness movement suppresser includes a first attachment that is attached to the pressure receiver.

3. The vehicle seat according to claim 2, wherein
the pressure receiver includes a flat portion that includes a flat region, and
the first attachment is attached to the flat portion.

4. The vehicle seat according to claim 3, wherein
an attachment hole is formed in the flat portion, and
the first attachment is a hook-shaped member and is attached to the attachment hole.

5. The vehicle seat according to claim 2, wherein
the cushion frame includes a pan frame that is disposed forward of the first connecting frame,
the electric component is mounted to the pan frame, with a bracket interposed between the electric component and the pan frame, and
the harness movement suppresser includes a second attachment that is attached to the bracket.

6. The vehicle seat according to claim 5, wherein the second attachment is attached at a position that is higher than a position of the first attachment.

7. The vehicle seat according to claim 5, wherein
a hook is provided to the bracket, and
the second attachment is a band member that has elasticity, and is attached to the hook.

8. The vehicle seat according to claim 1, wherein the harness movement suppresser is a sheet-shaped member.

9. The vehicle seat according to claim 6, wherein
the harness movement suppresser is a sheet-shaped member, and
a width of one end side of the sheet-shaped member at which the second attachment is provided is wider than a width of another end side of the sheet-shaped member at which the first attachment is provided.

10. The vehicle seat according to claim 8, wherein a width of the harness movement suppresser is shorter than a width of the pressure receiver.

11. The vehicle seat according to claim 10, wherein the harness movement suppresser is disposed being biased toward a side of a location where the electric component is installed, in a width direction of the cushion frame.
